(19) United States
(12) Patent Application Publication
(10) Pub. No.: US 2008/0279144 A1
(43) Pub. Date: Nov. 13, 2008

(54) WIRELESS ACCESS NETWORK SYSTEM, MANAGEMENT DEVICE, AND RESOURCE MANAGEMENT METHOD

(76) Inventor: Tsuneyuki Kikuchi, Tokyo (JP)

Correspondence Address: NEC CORPORATION OF AMERICA, 6535 N. STATE HWY 161, IRVING, TX, 75039, US

(21) Appl. No.: 12/118,424

(22) Filed: May 9, 2008

(30) Foreign Application Priority Data
May 9, 2007 (JP) 2007-124030

(51) Int. Cl. H04Q 7/00

(52) U.S. Cl. 370/329

(57) ABSTRACT

A wireless access network system includes a wireless access network device and a management device. A resource of the wireless access network device is shared by a plurality of common carriers. The management device stores shared information defining a common carrier authorized to use a resource in shared information memory, and determines whether or not a call requesting to capture a resource is permitted to use the resource by referring to the shared information in the shared information memory.

This application is based upon and claims the benefit of priority from Japanese Patent Application No. 2007-124030 filed on May 9, 2007, the content of which is incorporated by reference.

### BACKGROUND OF THE INVENTION

1. Field of the Invention

The present invention relates to resource management in a wireless access network in which a plurality of service providers can share a resource.

2. Description of the Related Art

In a wireless access network represented by W-CDMA (wideband-code division multiple access), a common carrier normally acquires a frequency license to establish and operate radio equipment. Therefore, in the wireless access network, there is normally a heavy responsibility on the initial spending on new plant and equipment, and it is hard to quickly expand an available area.

The size of the available area is an important factor when a user selects a new service and a common carrier. A common carrier cannot expect a rapidly increasing number of new subscribers until a certain size of an available area can be obtained. Therefore, a long time is required to recover the initial investment, and the common carrier cannot afford to spend money for subsequent investment, resulting in delaying the commencement of business.

In this respect, there is a system in which a service provider that has radio equipment can lease this equipment to another service provider and collect an equipment lease fee that depends upon the amount of communications and the length of communication time, thereby reducing the amount of expenditures on new plants and equipment (Japanese Patent Laid-Open No. 2002-348066).

However, in a wireless access network in which a service provider who has radio equipment leases it to another service provider, the radio resource is reserved in the order in which a connection request is accepted regardless of whether a service provider leases equipment to another service provider or whether a service provider leases equipment from another service provider. In this case, there is the possibility that a user of the service provider leasing the radio equipment from another service provider occupies the radio resource, while a user of the service provider that has the radio equipment and that leases the radio equipment to the other cannot use the service. Inversely, there can be the possibility that a user of the service provider that leases the radio equipment to another service provider occupies the radio resource and a user of the service provider that leases the radio equipment from the other cannot use the service.

### SUMMARY OF THE INVENTION

An exemplary object of the invention is to provide a technique which enables appropriately assigning a resource in a wireless access network in which a plurality of service providers shares the same resource.

To attain the above-mentioned exemplary object, the wireless access network system according to an exemplary aspect of the invention includes:

a wireless access network device in which a resource is shared among a plurality of common carriers; and

a management device for storing, in shared information memory, shared information in which a common carrier authorized to use the resource is defined, and for determining whether or not a resource capture request call is permitted to use the resource based on a common carrier to which the call belongs by referring to the shared information in the shared information memory.

The management device according to an exemplary aspect of the invention manages a resource in a wireless access network shared among a plurality of common carriers, and includes:

shared information memory storing shared information in which a common carrier authorized to use the resource in the wireless access network is defined; and

a processing unit for referring to the shared information in the shared information memory as to whether or not a call requesting to capture a resource is permitted to use the resource, thereby determining permission based on a common carrier to which the call belongs.

The resource management method according to an exemplary aspect of the invention manages a resource in a wireless access network shared among a plurality of common carriers, and includes:

storing shared information in which a common carrier authorized to use the resource in the wireless access network is defined; and

determining whether or not a call requesting to capture a resource is permitted to use the resource based on a common carrier to which the call belongs by referring to the shared information in the shared information memory.

A recording medium according to an exemplary aspect of the invention stores a resource management program for managing a resource in a wireless access network shared among a plurality of common carriers, and is used to direct a computer to perform:

a procedure of storing shared information in which a common carrier authorized to use the resource in the wireless access network is defined; and

a procedure of determining whether or not a call requesting to capture a resource is permitted to use the resource based on a common carrier to which the call belongs by referring to the shared information in the shared information memory.

The above and other objects, features, and advantages of the present invention will become apparent from the following description with references to the accompanying drawings which illustrate examples of the present invention.

### BRIEF DESCRIPTION OF THE DRAWINGS

FIG. 1 is a block diagram of a configuration of the wireless access network according to an exemplary embodiment of the present invention;

FIG. 2 is a block diagram showing an example of a configuration of the management device shown in FIG. 1;

FIG. 3 shows an example of a configuration of the first table shown in FIG. 2;

FIG. 4 shows an example of a configuration of the second table shown in FIG. 2;

FIG. 5 shows an example of a configuration of the third table shown in FIG. 2; and

FIG. 6 is a sequence chart showing the operations in the wireless access network according to an exemplary embodiment of the present invention.

### DETAILED DESCRIPTION OF THE PREFERRED EMBODIMENTS

An exemplary embodiment of the present invention is described below with reference to the attached drawings.

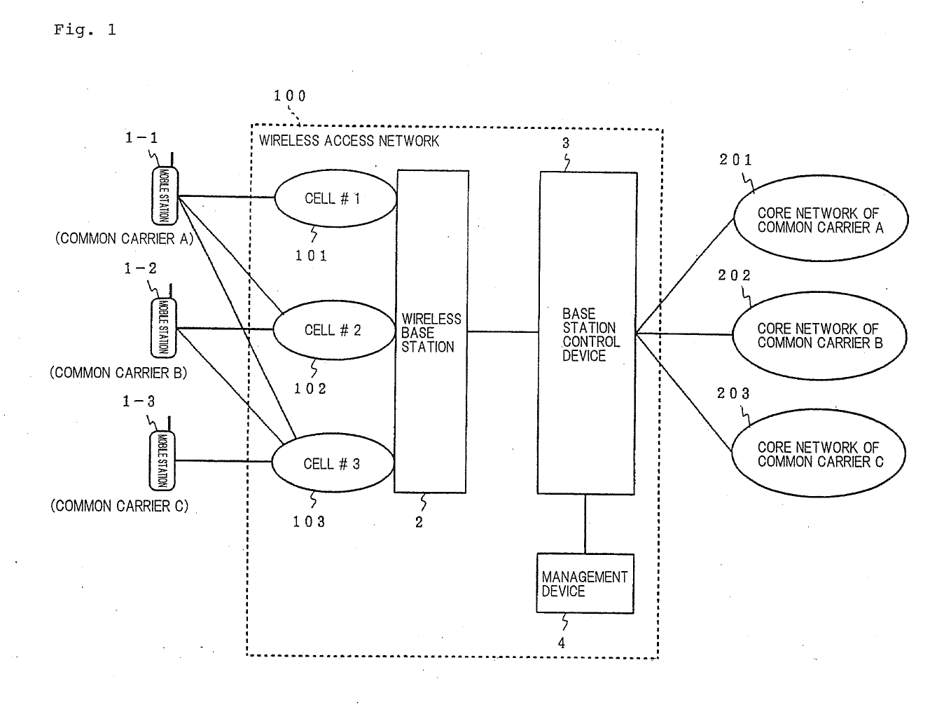

FIG. 1 is a block diagram showing the configuration of the wireless access network according to an exemplary embodiment of the present invention. In FIG. 1, wireless access network 100 is configured by wireless base station 2, base station control device 3, and management device 4. Wireless base station 2 manages cell # 1 101, cell # 2 102, and cell # 3 103. Wireless access network 100 connects mobile station 1-1 of common carrier A to core network 201 of the common carrier A, mobile station 1-2 of common carrier B to core network 202 of common carrier B, and mobile station 1-3 of common carrier C to core network 203 of common carrier C.

Wireless access network 100 according to the present exemplary embodiment is configured by radio equipment including wireless base station 2 and base station control device 3, and cable equipment such as a cable (not shown in the attached drawings), a router (not shown in the attached drawings), etc. The equipment is shared among a plurality of common carriers. A radio resource in wireless access network 100 includes a non-shared cell for use by only one common carrier, and a shared cell for use by a plurality of common carriers. A cable resource includes a non-shared band for use by only one common carrier, and a shared band for use by a plurality of common carriers.

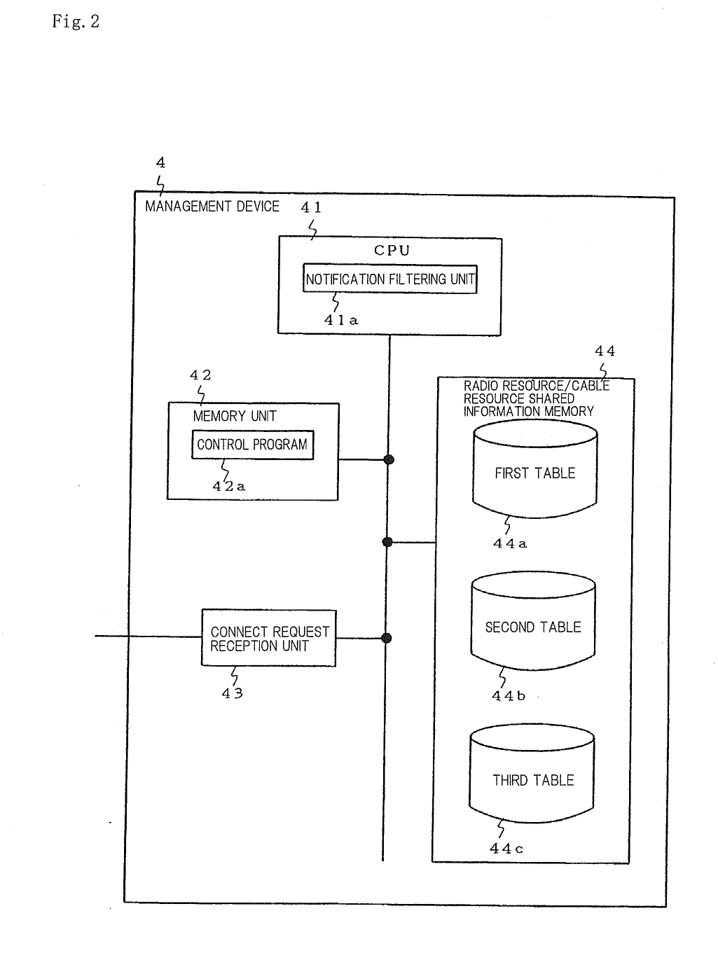

FIG. 2 is a block diagram showing an example of a configuration of management device 4 shown in FIG. 1. In FIG. 2, management device 4 includes CPU (central processing unit) 41, memory unit 42, connect request reception unit 43, and radio resource/cable resource shared information memory 44.

CPU 41 is provided with notification filtering unit 41a. Memory unit 42 stores control program 42a. Radio resource/cable resource shared information memory 44 is provided with first table 44a, second table 44b, and third table 44c.

Management device 4 is provided for a facility in which both the radio resource and the cable resource are managed. In the present exemplary embodiment, for example, management device 4 is located together with base station control device 3, and is connected to base station control device 3. However, the present invention is not limited to this configuration.

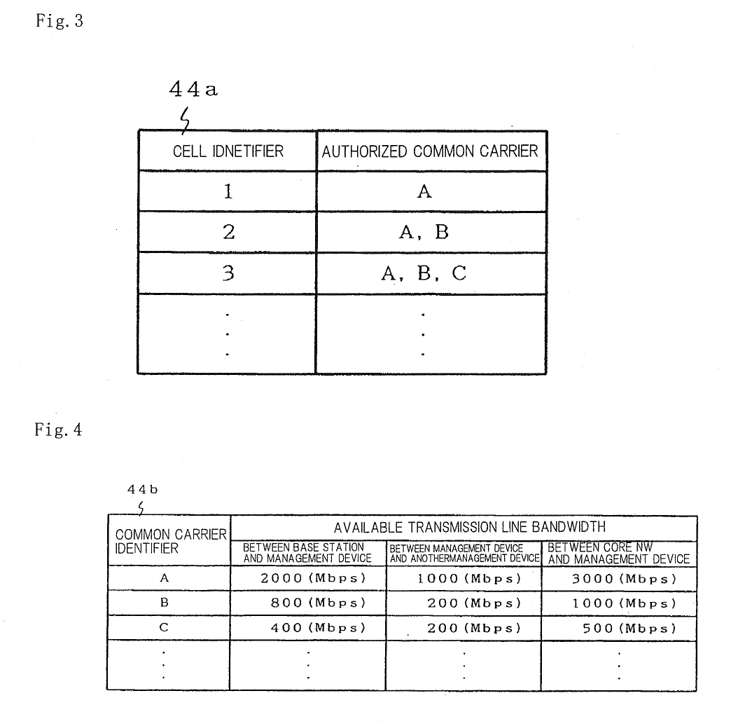

FIG. 3 shows an example of a configuration of first table 44a shown in FIG. 2. Referring to FIG. 3, first table 44a stores information that shows the correspondence relationship between a cell identifier (“1”, “2”, “3”, . . . ) and a common carrier identifier (“^{A}”, “B”, “C”, . . . ) for common carriers authorized to use each cell.

FIG. 4 shows an example of a configuration of second table 44b shown in FIG. 2. Referring to FIG. 4, second table 44b stores the information about the correspondence relationship between a common carrier identifier (“A”, “B”, “C”, . . . ) and an available transmission line bandwidth (between a base station and a management device, between a management device and another management device, and between a core NW and a management device).

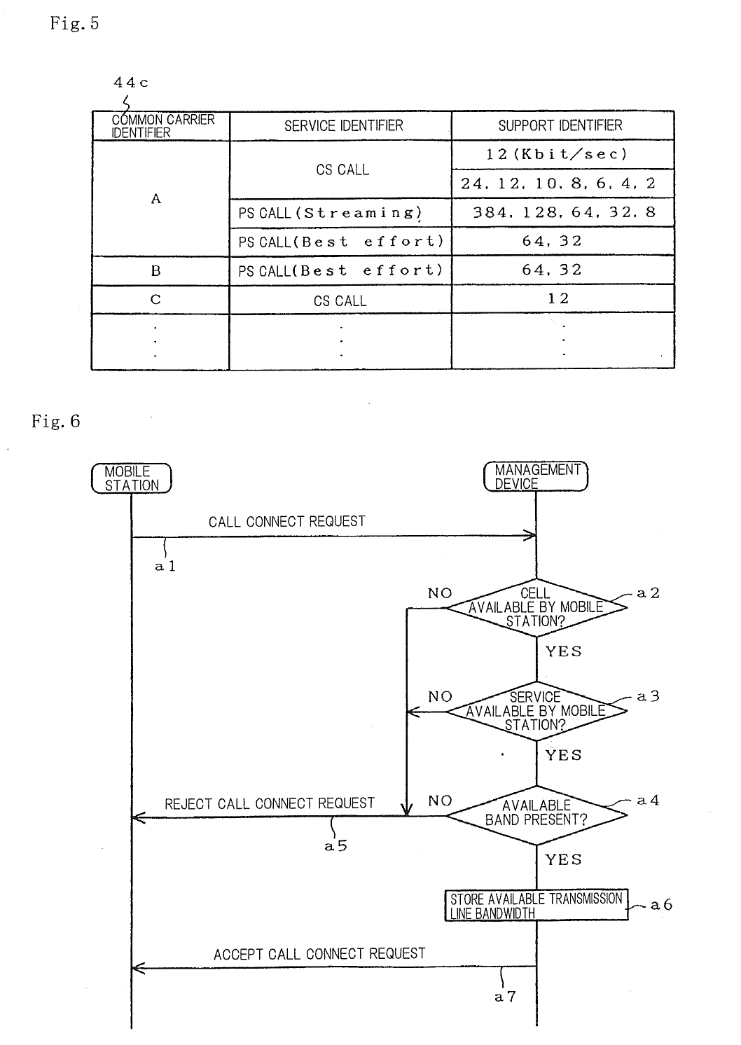

FIG. 5 shows an example of a configuration of third table 44c shown in FIG. 2. Referring to FIG. 5, third table 44c stores the information that shows the correspondence relationship between a common carrier identifier (“A”, “B”, “C”, . . . ), a service identifier [CS (circuit switching) call, PS (packet switching) call (streaming), PS call (best effort)], and a support identifier.

FIG. 6 is a sequence chart showing the operations of wireless access network 100 according to the present exemplary embodiment. Referring to FIGS. 1 to 6, in wireless access network 100 according to the present exemplary embodiment, an operation for determining whether or not a radio and/or cable resource capture request can be accepted is also described below. In this operation, a determination is made at the time when a radio and/or cable resource capture request is issued. The determination is also performed with reference to shared information tables 44a to 44c. The operation of management device 4 shown in FIG. 6 is performed by CPU 41 executing control program 42a.

Management device 4 is provided with first table 44a (FIG. 3), second table 44b (FIG. 4), and third table 44c (FIG. 5). First table 44a is defined on an equipment lease contract between a plurality of common carriers, and shows the correspondence between a cell identifier identifying a radio resource (cell) that is to be captured and a common carrier identifier identifying a common carrier that is authorized to use the cell. Second table 44b shows the correspondence between a common carrier identifier identifying a common carrier and a transmission line bandwidth available for mobile stations 1-1 to 1-3 under contract with the common carrier. Third table 44c shows the correspondence among a common carrier identifier identifying a common carrier and a service identifier identifying a communication service available for mobile stations 1-1 to 1-3 under contract with the common carrier, and a transmission line bandwidth (support identifier) available for the service.

Upon receipt of a call connect request from mobile stations 1-1 to 1-3 through connect request reception unit 43 (a1 shown in FIG. 6), management device 4 refers to first table 44a through notification filtering unit 41a and checks whether or not a cell is available for the common carrier (a2 shown in FIG. 6), control is passed to process a3 if the cell is available, and the request is rejected if it is not available (a5 shown in FIG. 6). In this case, the call connect request from mobile stations 1-1 to 1-3 includes a cell identifier of a cell requesting a connection, and a common carrier identifier of the common carrier under contract with mobile stations 1-1 to 1-3.

Since a call connect request includes a service identifier identifying the service to be used after a connection, management device 4 refers to third table 44c through notification filtering unit 41a, and checks whether or not the service is available for mobile stations 1-1 to 1-3 under contract with the common carrier (a3 shown in FIG. 6). Management device 4 goes to the process of a4 if the service is available, and rejects the request if it is not available (a5 shown in FIG. 6).

The available transmission line bandwidth for mobile stations 1-1 to 1-3 is added up for each common carrier and stored in memory unit 42. Management device 4 selects a bandwidth from third table 44c within the scope of the available transmission line bandwidth defined in second table 44b in notification filtering unit 41a (a4 shown in FIG. 6). Furthermore, management device 4 stores an updated available transmission line bandwidth in memory unit 42 (a6 shown in FIG. 6), and reports the reception of a call connect request to mobile stations 1-1 to 1-3 (a7 shown in FIG. 6). When a bandwidth cannot be selected, the request is rejected (a5 shown in FIG. 6).

In wireless access network 100 according to the present exemplary embodiment, it is assumed that each time mobile stations 1-1 to 1-3 enter a new position registration area, the position information is reported to core networks 201 to 203 of the common carriers. Management device 4 refers to first table 44a and selects a cell available for mobile stations 1-1 to 1-3 under contract with the common carrier, and notifies mobile stations 1-1 to 1-3 of the list of adjacent cells as targets of position registration, thereby being able to omit not only the above-mentioned process of a2, but also an unnecessary call connect request and a sequence of corresponding rejection thereto.

In wireless access network 100 according to the present exemplary embodiment, it is assumed that a cell at the handover destination is determined according to the report of the quality of the adjacent cell from mobile stations 1-1 to 1-3. Management device 4 refers to first table 44a, selects a cell available for mobile stations 1-1 to 1-3 under contract with the common carrier, and notifies mobile stations 1-1 to 1-3 of the list of adjacent cells to be quality-checked, thereby successfully being able to omit not only the above-mentioned process of a2, but also a sequence of an unnecessary call connect request and the related rejection response even when capture of a radio and/or cable resource is required at handover.

The present exemplary embodiment can also be applied to the case where there are a plurality of cable resources (transmission lines) between nodes and a shared information table of the cable resources is arranged.

According to the present exemplary embodiment, management device 4 stores, in shared information memory 44, shared information in which the common carrier authorized to use the resource in wireless access network 100 is defined, determines whether or not a call requesting to capture a resource is permitted to use the resource based on the common carrier to which the call belongs by referring to the shared information in shared information memory 44. Therefore, a resource can be appropriately assigned in wireless access network 100 in which resources are shared among a plurality of common carriers. Even in the case where a common carrier acquires a frequency license, and establishes radio equipment and cable equipment, and the common carrier having the radio equipment leases the radio equipment to another common carrier in the own wireless access network 100, for example, a user under contract with the common carrier leasing radio equipment from another common carrier can be prevented from occupying the radio resource, and a user of the common carrier having the radio equipment can use the service.

Furthermore, management device 4 determines acceptance/rejection of a request by using both the shared information table about radio resources and the shared information table about cable resources at the time when a resource capture request such as a call connect request, a handover request, etc. is issued.

In addition, the present exemplary embodiment can limit the number of adjacent cells to a predetermined number or less when management device 4 notifies mobile stations 1-1 to 1-3 of the list of adjacent cells to be position-registered in wireless access network 100 in which mobile stations 1-1 to 1-3 reports the position information each time they enter a new position registration area to a common carrier.

Furthermore, according to the present exemplary embodiment, the number of adjacent cells can be limited to a predetermined number or less when management device 4 notifies mobile stations 1-1 to 1-3 of the list of adjacent cells to be quality-checked in wireless access network 100 in which a cell at handover destination is determined based on the adjacent cell quality report from mobile stations 1-1 to 1-3.

According to the present exemplary embodiment, management device 4 can be provided with a shared information table of cable resources for defining a transmission line bandwidth available for a common carrier, and a request can be accepted/rejected based on the shared information table at the time when a resource capture request such as a call connect request, a handover request, etc. is issued.

While preferred exemplary embodiments of the present invention have been described using specific terms, such description is for illustrative purposes only, and it is to be understood that changes and variations may be made without departing from the spirit or scope of the following claims.

What is claimed is:

1. A wireless access network system, comprising:
a wireless access network device in which a resource is shared among a plurality of common carriers; and
a management device for storing, in shared information memory, shared information in which a common carrier authorized to use the resource is defined, and for determining whether or not a call requesting to capture a resource is permitted to use the resource based on a common carrier to which the call belongs by referring to the shared information in the shared information memory.

2. The wireless access network system according to claim 1, wherein
the shared information comprises a first table associating a radio resource with a common carrier authorized to use the radio resource.

3. The wireless access network system according to claim 2, wherein:
the radio resource is a cell in the wireless access network;
a mobile station using the wireless access network has a function of reporting a new position registration area when the station moves between position registration areas; and
the management device refers to the first table, selects an adjacent cell available for a common carrier under contract with the mobile station in cells adjacent to a cell in which the mobile station is located, and notifies the mobile station of a list of selected adjacent cells to be position-registered.

4. The wireless access network system according to claim 2, wherein:
the radio resource is a cell in the wireless access network;
a mobile station using the wireless access network has a function of reporting the quality of an adjacent cell;
the wireless access network determines a cell at a handover destination of the mobile station based on the report of the quality of the adjacent cell from the mobile station; and
the management device refers to the first table, selects an adjacent cell available for a common carrier under contract with the mobile station in cells adjacent to a cell in which the mobile station is located, and notifies the mobile station of a list of selected adjacent cells to be quality-checked.

5. The wireless access network system according to claim 3, wherein:
the shared information further comprises a second table associating a common carrier with a cable resource available for the common carrier; and
the management device determines whether or not use of the resource is permitted for a call requesting to capture a resource based on a common carrier to which the call belongs by referring to the second table.

6. A management device which manages a resource in a wireless access network shared among a plurality of common carriers, comprising:
shared information memory storing shared information in which a common carrier authorized to use the resource in the wireless access network is defined; and
a processing unit for determining whether or not a call requesting to capture a resource is permitted to use the resource based on a common carrier to which the call belongs by referring to the shared information in the shared information memory.

7. The management device according to claim 6, wherein
the shared information comprises a first table associating a radio resource with a common carrier authorized to use the radio resource.

8. The management device according to claim 7, wherein:
the radio resource is a cell in the wireless access network;
a mobile station using the wireless access network has a function of reporting a new position registration area when the station moves between position registration areas; and
the processing unit refers to the first table, selects an adjacent cell available for a common carrier under contract with the mobile station in cells adjacent to a cell in which the mobile station is located, and notifies the mobile station of a list of selected adjacent cells to be position-registered.

9. The management device according to claim 7, wherein:
the radio resource is a cell in the wireless access network;
a mobile station using the wireless access network has a function of reporting the quality of an adjacent cell;
the wireless access network determines a cell at a handover destination of the mobile station based on the report of the quality of the adjacent cell from the mobile station; and
the processing unit refers to the first table, selects an adjacent cell available for a common carrier under contract with the mobile station in cells adjacent to a cell in which the mobile station is located, and notifies the mobile station of a list of selected adjacent cells to be quality-checked.

10. The management device according to claim 8, wherein:
the shared information further comprises a second table associating a common carrier with a cable resource available for the common carrier; and
the processing unit determines whether or not a call requesting to capture a resource is permitted to use the resource based on the common carrier to which the call belongs by referring to the second table.

11. A management device which manages a resource in a wireless access network shared among a plurality of common carriers, comprising:
shared information storing means for storing shared information in which a common carrier authorized to use the resource in the wireless access network is defined; and
processing means for determining whether or not a call requesting to capture a resource is permitted to use the resource based on a common carrier to which the call belongs by referring to the shared information in the shared information storing means.

12. The resource management method for managing a resource in a wireless access network shared among a plurality of common carriers, comprising:
storing shared information in which a common carrier authorized to use the resource in the wireless access network is defined; and
determining whether or not a call requesting to capture a resource is permitted to use the resource based on a common carrier to which the call belongs by referring to the shared information in the shared information memory.

13. A recording medium storing a resource management program for managing a resource in a wireless access network shared among a plurality of common carriers, and that is used to direct a computer to perform:
a procedure for storing shared information in which a common carrier authorized to use the resource in the wireless access network is defined; and
a procedure for determining whether or not a call requesting to capture a resource is permitted to use the resource based on a common carrier to which the call belongs by referring to the shared information in the shared information memory.
